(19) United States
(12) Patent Application Publication
(10) Pub. No.: US 2024/0123498 A1
(43) Pub. Date: Apr. 18, 2024

(54) ADDITIVE MANUFACTURING POWDER AND ADDITIVELY MANUFACTURED OBJECT

(71) Applicant: SEIKO EPSON CORPORATION, TOKYO (JP)

(72) Inventors: Momoko WAKABAYASHI, Hachinohe-shi (JP); Yasutaka MATSUMOTO, Suwa-shi (JP)

(21) Appl. No.: 18/476,696

(22) Filed: Sep. 28, 2023

(30) Foreign Application Priority Data
Sep. 30, 2022 (JP) 2022-158426

(51) Int. Cl. B22F 1/102; B22F 1/05; B22F 1/142; B22F 10/14

(52) U.S. Cl. CPC B22F 1/102; B22F 1/05; B22F 1/142; B22F 10/14; B33Y 70/00

(57) ABSTRACT

An additive manufacturing powder includes: a metal powder; and a film provided on a particle surface of the metal powder and containing a compound derived from a coupling agent having a hydrophobic functional group. An average particle diameter is 3.0 μm or more and 30.0 μm or less, and a water amount is measured by a Karl Fischer method before and after the additive manufacturing powder is subjected to a heat treatment at 200° C. for 24 hours in an air atmosphere, and when the water amount before the heat treatment is set to 1, the water amount after the heat treatment is 0.85 or more and 1.15 or less in terms of mass ratio.

The present application is based on, and claims

priority from JP Application Serial Number 2022-158426, filed Sep. 30, 2022, the disclosure of which is hereby incorporated by reference herein in its entirety.

### BACKGROUND

### 1. Technical Field

The present disclosure relates to an additive manufacturing powder and an additively manufactured object.

### 2. Related Art

In recent years, additive manufacturing methods using metal powders are widespread as a technique for manufacturing three-dimensional objects. This technique is a technique of manufacturing a three-dimensional object including a step of calculating a cross-sectional shape of a three-dimensional object obtained by thinly slicing the three-dimensional object on a plane orthogonal to a lamination direction, a step of forming a powder layer by forming a metal powder in a layer form, and a step of binding a part of the powder layer based on the shape obtained by the calculation, in which the step of forming a powder layer and the step of binding a part of the powder layer are repeated.

Fused deposition modeling (FDM), selective laser sintering (SLS), a binder jet method, and the like are known as additive manufacturing methods according to binding principles.

JP-T-2021-532274 discloses a method for preparing a matrix composite material by, for example, preparing a green body (molded body) having a desired pattern by a binder jet method in which a liquid binder is sprayed onto a powder bed in a predetermined pattern, then curing the binder, and then sintering the green body.

In addition, JP-T-2021-532274 discloses that core particles containing a metal are subjected to a process of atomic layer deposition (ALD) or molecular layer deposition (MLD) to produce a powder (coating powder) containing a coating of ALD or MLD, and the powder bed for producing the green body is prepared using the powder.

In the binder jet method, the coating powder in a portion where the binder is not sprayed is collected and reused. Accordingly, the wasted coating powder can be reduced, and a cost of the additive manufacturing method can be reduced.

However, the coating described in JP-T-2021-532274 is not derived from a coupling agent. Therefore, even after the coating, an influence of a hydroxy group present on a surface of the core particles is likely to remain, and characteristics are likely to change with time due to moisture absorption in the air. In this case, there is a concern that the characteristics change before and after the reuse, and quality of an additively manufactured object deteriorates. Therefore, development of an additive manufacturing powder that enables favorable additive manufacturing even when reused becomes a problem.

### SUMMARY

An additive manufacturing powder according to an application example of the present disclosure includes: a metal powder; and a film provided on a particle surface of the metal powder and containing a compound derived from a coupling agent having a hydrophobic functional group. An average particle diameter is 3.0 μm or more and 30.0 μm or less, and a water amount is measured by a Karl Fischer method before and after the additive manufacturing powder is subjected to a heat treatment at 200° C. for 24 hours in an air atmosphere, and when the water amount before the heat treatment is set to 1, the water amount after the heat treatment is 0.85 or more and 1.15 or less in terms of mass ratio.

An additively manufactured object according to an application example of the present disclosure contains: the additive manufacturing powder according to an application example of the present disclosure; and a binder that binds particles of the additive manufacturing powder together.

### BRIEF DESCRIPTION OF THE DRAWINGS

FIG. 1 is a step diagram showing a method for producing an additively manufactured object.

FIG. 2 is a diagram showing the method for producing an additively manufactured object shown in FIG. 1.

FIG. 3 is a diagram showing the method for producing an additively manufactured object shown in FIG. 1.

FIG. 4 is a diagram showing the method for producing an additively manufactured object shown in FIG. 1.

FIG. 5 is a diagram showing the method for producing an additively manufactured object shown in FIG. 1.

FIG. 6 is a diagram showing the method for producing an additively manufactured object shown in FIG. 1.

FIG. 7 is a diagram showing the method for producing an additively manufactured object shown in FIG. 1.

FIG. 8 is a diagram showing the method for producing an additively manufactured object shown in FIG. 1.

FIG. 9 is a diagram showing the method for producing an additively manufactured object shown in FIG. 1.

FIG. 10 is a diagram showing the method for producing an additively manufactured object shown in FIG. 1.

FIG. 11 is a cross-sectional view schematically showing an additive manufacturing powder according to an embodiment.

FIG. 12 is a step diagram showing a method for producing the additive manufacturing powder.

FIG. 13 is a graph comparing a bending stress of an additively manufactured object prepared using a powder in Example 1 and a bending stress of an additively manufactured object prepared using a powder in Comparative Example 1 among measurement results of bending stresses shown in Table 2.

FIG. 14 is a graph showing a relationship between a heating time and each bulk density of the powder in Example 1 and the powder in Comparative Example 1.

FIG. 15 is a graph showing a relationship between a water amount and the number of times of heat treatment for the powder in Example 1 and the powder in Comparative Example 1.

FIG. 16 is a graph showing a relationship between a tap density and the number of times of heat treatment for the powder in Example 1 and the powder in Comparative Example 1.

### DESCRIPTION OF EMBODIMENTS

Hereinafter, an additive manufacturing powder and an additively manufactured object according to preferred embodiments of the disclosure will be described in detail with reference to the accompanying drawings.

### 1. Method for Producing Additively Manufactured Object

First, a method for producing an additively manufactured object using an additive manufacturing powder will be described.

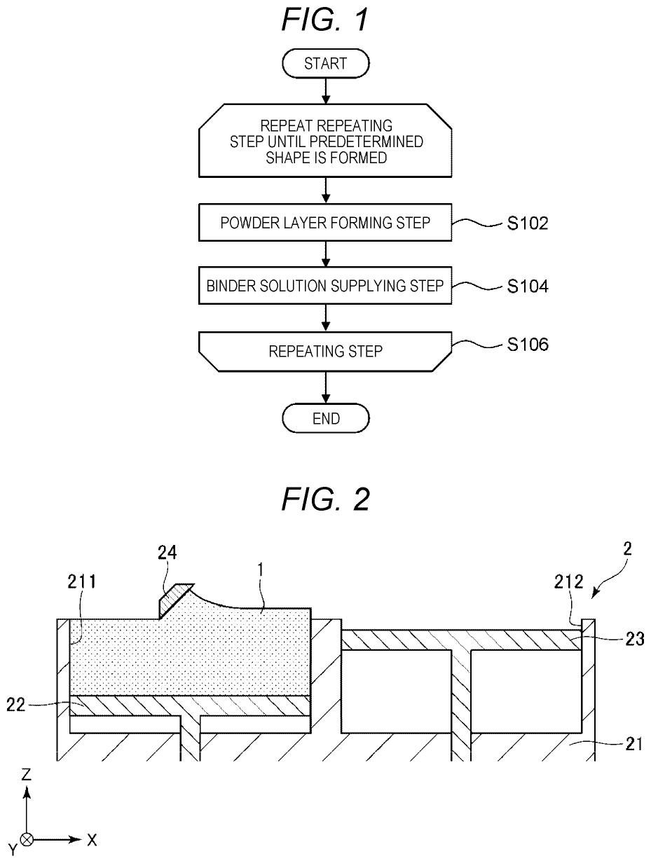

FIG. 1 is a step diagram showing a method for producing an additively manufactured object. FIGS. 2 to 10 are diagrams showing the method for producing an additively manufactured object shown in FIG. 1. In the drawings of the present application, an X-axis, a Y-axis, and a Z-axis are set as three axes orthogonal to one another. Each axis is indicated by an arrow, and a tip end side is referred to as “plus side” and a base end side is referred to as “minus side”. In the following description, in particular, a plus side of the Z-axis is referred to as “upper”, and a minus side of the Z-axis is referred to as “lower”. Both directions parallel to the X-axis are referred to as an X-axis direction, both directions parallel to the Y-axis are referred to as a Y-axis direction, and both directions parallel to the Z-axis are referred to as a Z-axis direction.

The method for producing an additively manufactured object shown in FIGS. 1 to 10 is a method referred to as a binder jet method, which is a type of additive manufacturing method, and includes a powder layer forming step S102, a binder solution supplying step S104, and a repeating step S106 as shown in FIG. 1.

In the powder layer forming step S102, a powder layer 31 is formed by spreading an additive manufacturing powder 1. In the binder solution supplying step S104, a binder solution 4 is supplied to a predetermined region of the powder layer 31 to bind particles in the powder layer 31 together, thereby obtaining a bound layer 41. In the repeating step S106, the powder layer forming step S102 and the binder solution supplying step S104 are repeated one or more times, to obtain an additively manufactured object 6 shown in FIG. 10. Hereinafter, each step will be sequentially described.

### 1.1. Additive Manufacturing Apparatus

First, before the description of the powder layer forming step S102, an additive manufacturing apparatus 2 will be described.

The additive manufacturing apparatus 2 includes an apparatus main body 21 provided with a powder storage unit 211 and a manufacturing unit 212, a powder supply elevator 22 provided in the powder storage unit 211, a manufacturing stage 23 provided in the manufacturing unit 212, and a coater 24, a roller 25, and a solution supply unit 26 movably provided on the apparatus main body 21.

The powder storage unit 211 is a recessed portion provided in the apparatus main body 21 and having an open upper portion. The additive manufacturing powder 1 is stored in the powder storage unit 211. Then, an appropriate amount of the additive manufacturing powder 1 stored in the powder storage unit 211 is supplied to the manufacturing unit 212 by the coater 24.

The powder supply elevator 22 is disposed at a bottom portion of the powder storage unit 211. The powder supply elevator 22 is movable in a vertical direction with the additive manufacturing powder 1 placed thereon. By moving the powder supply elevator 22 upward, the additive manufacturing powder 1 placed on the powder supply elevator 22 is pushed up and forced out of the powder storage unit 211. Accordingly, the forced-out additive manufacturing powder 1 can be moved to a manufacturing unit 212 side.

The manufacturing unit 212 is a recessed portion provided in the apparatus main body 21 and having an open upper portion. The manufacturing stage 23 is disposed in the manufacturing unit 212. On the manufacturing stage 23, the additive manufacturing powder 1 is spread in a layer form by the coater 24. The manufacturing stage 23 is movable in the vertical direction with the additive manufacturing powder 1 spread thereon. By appropriately setting a height of the manufacturing stage 23, an amount of the additive manufacturing powder 1 spread on the manufacturing stage 23 can be adjusted.

The coater 24 and the roller 25 are movable in the X-axis direction from the powder storage unit 211 to the manufacturing unit 212. The coater 24 pulls the additive manufacturing powder 1, so that the additive manufacturing powder 1 can be flattened and can be spread in the layer form. The roller 25 compresses the flattened additive manufacturing powder 1 from above.

The solution supply unit 26 is implemented by, for example, an inkjet head or a dispenser, and is movable in the manufacturing unit 212 in the X-axis direction and the Y-axis direction. The solution supply unit 26 can supply a target amount of the binder solution 4 to a target position. The solution supply unit 26 may include a plurality of ejection nozzles in one head. The binder solution 4 may be discharged simultaneously or with a time difference from the plurality of ejection nozzles.

### 1.2. Powder Layer Forming Step

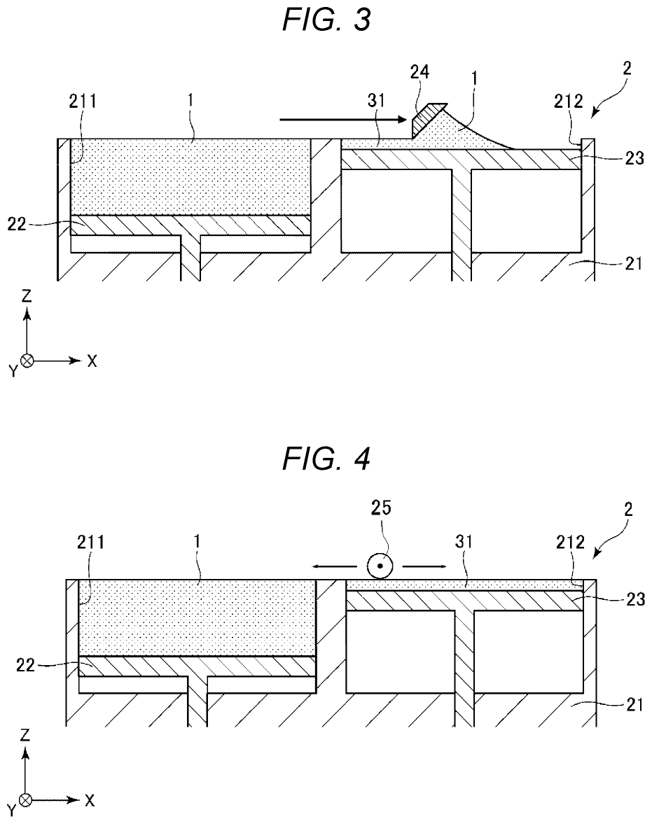

Next, the powder layer forming step S102 using the above-described additive manufacturing apparatus 2 will be described. In the powder layer forming step S102, the additive manufacturing powder 1 is spread on the manufacturing stage 23 to form the powder layer 31. Specifically, as shown in FIGS. 2 and 3, the additive manufacturing powder 1 stored in the powder storage unit 211 is pulled onto the manufacturing stage 23 and flattened to a uniform thickness with the coater 24. Accordingly, the powder layer 31 shown in FIG. 4 is obtained. At this time, the thickness of the powder layer 31 can be adjusted by lowering an upper surface of the manufacturing stage 23 below an upper end of the manufacturing unit 212 and adjusting a lowering amount. As will be described later, the additive manufacturing powder 1 is a powder having an excellent filling property when being flattened. Therefore, the powder layer 31 having a high filling rate can be obtained.

Next, as shown in FIG. 4, the roller 25 is moved in the X-axis direction while the powder layer 31 is compressed in a thickness direction by the roller 25. Accordingly, the filling rate of the additive manufacturing powder 1 in the powder layer 31 can be increased. The compression performed by the roller 25 may be performed as needed, or may be omitted. The powder layer 31 may be compressed by a unit different from the roller 25, for example, a pressing plate.

### 1.3. Binder Solution Supplying Step

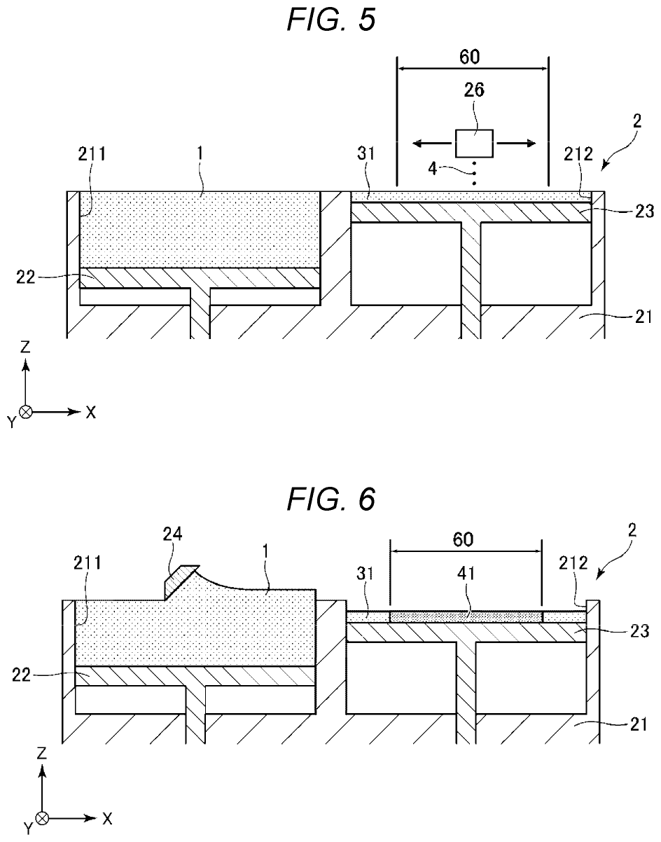

In the binder solution supplying step S104, as shown in FIG. 5, the solution supply unit 26 supplies the binder solution 4 to a formation region 60 of the powder layer 31 corresponding to the additively manufactured object 6 to be manufactured. The binder solution 4 is a solution containing a binder and a solvent or a dispersion medium. In the formation region 60 to which the binder solution 4 is supplied, the particles of the additive manufacturing powder 1 are bound to one another to obtain the bound layer 41 shown in FIG. 6. In the bound layer 41, the particles of the additive manufacturing powder 1 are bound together by the binder, and have a shape retention property to an extent of not breaking due to own weight.

The bound layer 41 may be heated at the same time as or after the supply of the binder solution 4. Accordingly, volatilization of the solvent or the dispersion medium contained in the binder solution 4 is promoted, and the binding of the particles due to solidification or curing of the binder is promoted. When the binder contains a photocurable resin or an ultraviolet curable resin, light irradiation or ultraviolet irradiation may be performed instead of or in combination with heating.

A heating temperature during the heating is not particularly limited, and is preferably 50° C. or higher and 250° C. or lower, and more preferably 70° C. or higher and 200° C. or lower. Accordingly, a sufficient amount of heat can be applied to the bound layer 41, and the volatilization of the solvent or the dispersion medium can be sufficiently promoted.

The binder solution 4 is not particularly limited as long as it is a solution containing a component capable of binding the particles of the additive manufacturing powder 1 together. Examples of the solvent or the dispersion medium in the binder solution 4 include water, alcohols, ketones, and carboxylic acid esters, and the solvent or the dispersion medium may be a mixed solution containing at least one of the above. Examples of the binder contained in the binder solution 4 include fatty acids, paraffin wax, microwax, polyethylene, polypropylene, polystyrene, acrylic resins, polyamide resins, polyesters, stearic acid, polyvinylpyrrolidone (PVP), polyvinyl alcohol (PVA), polyethylene glycol (PEG), urethane-based resins, epoxy-based resins, vinyl-based resins, unsaturated polyester-based resins, and phenol-based resins.

### 1.4. Repeating Step

In the repeating step S106, the powder layer forming step S102 and the binder solution supplying step S104 are repeated one or more times until a laminated body formed by laminating a plurality of the bound layers 41 has a predetermined shape. That is, these steps are performed two or more times in total. Accordingly, the three-dimensional additively manufactured object 6 shown in FIG. 10 is obtained.

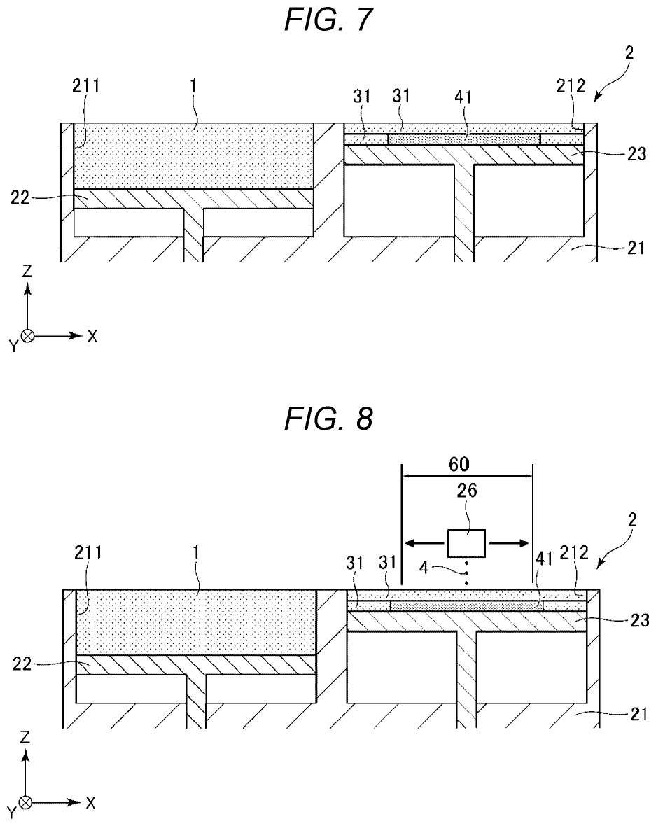

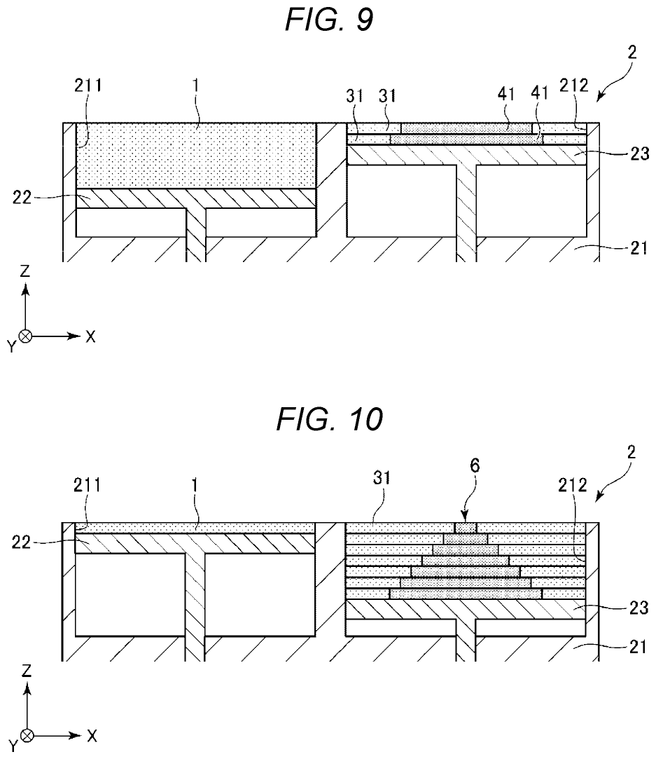

Specifically, first, as shown in FIG. 7, the new powder layer 31 is formed on the bound layer 41 shown in FIG. 6. Next, as shown in FIG. 8, the binder solution 4 is supplied to the formation region 60 of the newly formed powder layer 31. Accordingly, the bound layer 41 shown in FIG. 9 is obtained. By repeating this operation, the additively manufactured object 6 shown in FIG. 10 is obtained.

Among the powder layers 31, the additive manufacturing powder 1 that does not constitute the bound layers 41 is collected and reused as necessary, that is, used again for producing the additively manufactured object 6.

The additively manufactured object 6 obtained as described above is used for any application, for example, a structural part, a housing, a daily article, or a decoration article. In addition, as described later, the additively manufactured object 6 can be modified by performing any treatment, for example, a sintering treatment, on the additively manufactured object 6.

### 1.5. Method for Producing Metal Sintered Body

By performing a sintering treatment on the additively manufactured object 6, a metal sintered body is obtained. In the sintering treatment, the additively manufactured object 6 is heated to cause a sintering reaction.

A sintering temperature varies depending on a type, a particle diameter, and the like of the additive manufacturing powder 1, and as an example, is preferably 980° C. or higher and 1330° C. or lower, and more preferably 1050° C. or higher and 1260° C. or lower. A sintering time is preferably 0.2 hours or longer and 7 hours or shorter, and more preferably 1 hour or longer and 6 hours or shorter.

Examples of an atmosphere in the sintering treatment include a reducing atmosphere such as hydrogen, an inert atmosphere such as nitrogen and argon, and a reduced-pressure atmosphere obtained by reducing a pressure of the atmospheres of such gases. A pressure in the reduced-pressure atmosphere is not particularly limited as long as it is less than a normal pressure (100 kPa), and is preferably 10 kPa or less, and more preferably 1 kPa or less.

When the sintering treatment performed under the above-described conditions is referred to as “main sintering”, “temporary sintering” corresponding to a pre-treatment of the main sintering may be performed on the additively manufactured object 6 as necessary. Accordingly, at least a part of the binder contained in the additively manufactured object 6 can be removed, or the sintering reaction can be caused in a part of the additively manufactured object 6. Accordingly, when the main sintering is performed, a shrinkage rate can be decreased, and unintended deformation or the like can be prevented.

A temperature in the temporary sintering is not particularly limited as long as it is a temperature at which sintering of a metal powder does not complete, and is preferably 100° C. or higher and 500° C. or lower, and more preferably 150° C. or higher and 300° C. or lower. A time of the temporary sintering is preferably 5 minutes or longer, more preferably 10 minutes or longer and 120 minutes or shorter, and still more preferably 20 minutes or longer and 60 minutes or shorter in the temperature range. Examples of an atmosphere in the temporary sintering include an air atmosphere, an inert atmosphere such as nitrogen and argon, and a reduced-pressure atmosphere obtained by reducing a pressure of the atmospheres of such gases.

The metal sintered body obtained in the above manner can be used as a material constituting all or a part of, for example, transportation equipment parts such as automobile parts, bicycle parts, railroad vehicle parts, ship parts, aircraft parts, and space transportation parts, electronic device parts such as personal computer parts, mobile phone terminal parts, tablet terminal parts, and wearable terminal parts, parts for electrical equipment such as refrigerators, washing machines, and air conditioners, machine parts such as machine tools and semiconductor production devices, parts for plants such as nuclear power plants, thermal power plants, hydropower plants, refineries, and chemical complexes, watch parts, metal tableware, and ornaments such as jewelry and eyeglass frames.

### 2. Additive Manufacturing Powder

Next, the additive manufacturing powder according to the embodiment will be described.

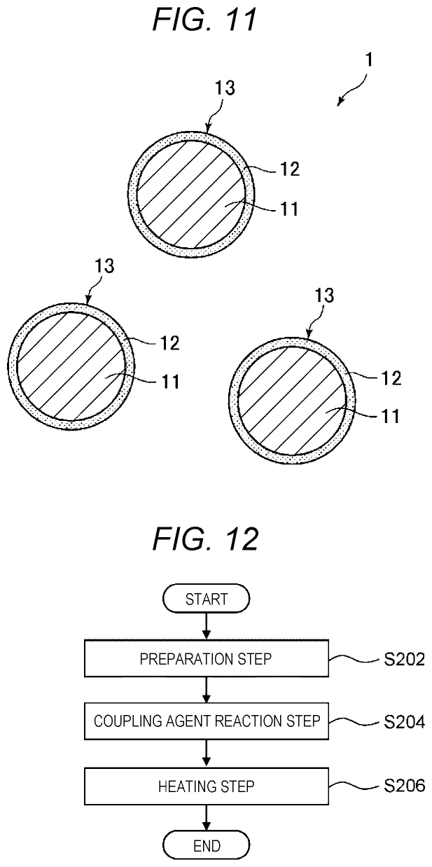

FIG. 11 is a cross-sectional view schematically showing the additive manufacturing powder according to the embodiment.

The additive manufacturing powder 1 according to the embodiment is a powder used in various additive manufacturing methods such as the binder jet method described above.

As shown in FIG. 11, the additive manufacturing powder 1 contains a plurality of surface-coated particles 13 each containing a metal particle 11 constituting the metal powder and a film 12 covering a surface of the metal particle 11. Since the additive manufacturing powder 1 containing such surface-coated particles 13 has high fluidity, a filling property thereof when being flattened is high.

### 2.1. Metal Particles

A constituent material of the metal particles 11 is not particularly limited, and may be any material as long as it has sinterability. Examples of the constituent material include simple substances such as Fe, Ni, Co, and Ti, and alloys and intermetallic compounds containing these simple substances as main components.

Examples of Fe-based alloys include stainless steels such as a ferritic stainless steel, an austenitic stainless steel, a martensitic stainless steel, and a precipitation hardening stainless steel, low carbon steels, carbon steels, heat resistant steels, die steels, high speed tool steels, Fe—Ni-based alloys, and Fe—Ni—Co-based alloys.

Examples of Ni-based alloys include Ni—Cr—Fe-based alloys, Ni—Cr—Mo-based alloys, and Ni—Fe-based alloys.

Examples of Co-based alloys include Co—Cr-based alloys, Co—Cr—Mo-based alloys, and Co—Al—W-based alloys.

Examples of Ti-based alloys include alloys of Ti and metal elements such as Al, V, Nb, Zr, Ta, and Mo, and specifically, Ti-6Al-4V and Ti-6Al-7Nb.

### 2.2. Film

The film 12 is formed by reacting a coupling agent having a hydrophobic functional group with the surface of the metal particle 11. Therefore, the film 12 contains a compound derived from the coupling agent having a hydrophobic functional group, and exhibits properties derived from the hydrophobic functional group.

Examples of the hydrophobic functional group include a cyclic structure-containing group, a fluoroalkyl group, a fluoroaryl group, a nitro group, an acyl group, and a cyano group. Among these, the hydrophobic functional group is preferably a cyclic structure-containing group, a fluoroalkyl group, or a fluoroaryl group. These groups give particularly high heat resistance to the film 12. Accordingly, it is possible to implement the additive manufacturing powder 1 capable of maintaining hydrophobicity and good fluidity even after being heated at a high temperature.

The cyclic structure-containing group is a functional group having a cyclic structure. Examples of the cyclic structure-containing group include an aromatic hydrocarbon group, an alicyclic hydrocarbon group, and a cyclic ether group.

The aromatic hydrocarbon group is a residue obtained by removing hydrogen from an aromatic hydrocarbon, and the number of carbon atoms is preferably 6 or more and 20 or less. Examples of the aromatic hydrocarbon group include an aryl group, an alkylaryl group, an aminoaryl group, and a halogenated aryl group. Examples of the aryl group include a phenyl group, a tolyl group, a xylyl group, a naphthyl group, and an indenyl group. Examples of the alkylaryl group include a benzyl group, a methylbenzyl group, a phenethyl group, a methylphenethyl group, and a phenylbenzyl group.

The alicyclic hydrocarbon group is a residue obtained by removing hydrogen from an alicyclic hydrocarbon, and the number of carbon atoms is preferably 3 or more and 20 or less. Examples of the alicyclic hydrocarbon group include a cycloalkyl group and a cycloalkylalkyl group. Examples of the cycloalkyl group include a cyclopropyl group, a cyclobutyl group, a cyclopentyl group, and a cyclohexyl group. Examples of the cycloalkylalkyl group include a cyclopentylmethyl group and a cyclohexylmethyl group.

Examples of the cyclic ether group include an epoxy group, a 3,4-epoxycyclohexyl group, and an oxetanyl group.

The fluoroalkyl group is an alkyl group having 1 or more and 16 or less carbon atoms or a cycloalkyl group having 3 or more and 16 or less carbon atoms substituted with 1 or more fluorine atoms. In particular, the fluoroalkyl group is preferably a perfluoroalkyl group.

The fluoroaryl group is an aryl group having 6 or more and 20 or less carbon atoms substituted with 1 or more fluorine atoms. In particular, the fluoroaryl group is preferably a perfluoroaryl group.

These hydrophobic functional groups have relatively good heat resistance. Therefore, the film 12 containing the compound derived from the coupling agent having these hydrophobic functional groups is not easily modified even in a high-temperature environment. Therefore, the surface-coated particles 13 maintain the hydrophobicity even in a high-temperature environment and are less likely to absorb moisture, and thus the fluidity is less likely to decrease. As a result, it is possible to obtain the additive manufacturing powder 1, which can be laminated well and can be used to produce the additively manufactured object 6 having high dimensional accuracy even when reused.

These hydrophobic functional groups also have good hydrophobicity. Therefore, the film 12 containing the compound derived from the coupling agent having these hydrophobic functional groups provides excellent fluidity to the additive manufacturing powder 1 even in a high-humidity environment.

An average thickness of the film 12 is not particularly limited, and is preferably 100 nm or less, more preferably 0.5 nm or more and 50 nm or less, and still more preferably 1 nm or more and 10 nm or less. Accordingly, a film thickness required to maintain the film 12 can be secured. The average thickness of the film 12 is, for example, a value obtained by averaging the film thicknesses of the film 12 acquired from an observation image at five or more points when cross sections of the particles of the additive manufacturing powder 1 are observed with a transmission electron microscope.

The film 12 may be a multilayer film in which molecules of the above-described compound are laminated in a plurality of layers, for example, 2 layers or more and 10 layers or less, and a monomolecular film made of the above-described compound is preferred. The thickness of the film 12 that is the monomolecular film can be minimized. As a result, it is possible to obtain the additively manufactured object 6 in which an occupancy of the films 12 is low and an occupancy of the metal particles 11 is high.

The monomolecular film is a film formed by self-assembly of the coupling agent. That is, according to the coupling agent, the molecules, which have affinity with the surfaces of the metal particles 11, are densely aligned on the surfaces, so that a film having a thickness of one molecule can be efficiently formed.

Whether the film 12 is a monomolecular film can be identified by, for example, qualitative and quantitative analysis in a depth direction using X-ray photoelectron spectroscopy and ion sputtering in combination. Specifically, a concentration of a component derived from the coupling agent is examined along the depth direction. If a region where the concentration of the component derived from the coupling agent is high is equal to or smaller than a molecular size of the coupling agent, the film 12 can be evaluated as a monomolecular film.

### 2.3. Various Characteristics

### 2.3.1. Water Amount

In the additive manufacturing powder 1 according to the embodiment, the water amount is measured before and after a heat treatment, and when the water amount before the heat treatment is set to 1, the water amount after the heat treatment is 0.85 or more and 1.15 or less in terms of mass ratio. The heat treatment is a treatment of heating the additive manufacturing powder 1 at 200° C. for 24 hours. The water amount is measured by a Karl Fischer method. If a change in water amount before and after the heat treatment satisfies the above condition, a change in a hygroscopic property of the additive manufacturing powder 1 can be reduced even in a high-temperature environment and a high-humidity environment. Therefore, even when such an additive manufacturing powder 1 is not used once when subjected to additive manufacturing and remains, there is little change in characteristics such as fluidity and it is suitable for reuse. In other words, the characteristics of the additive manufacturing powder 1 to be reused have a small difference from characteristics of the additive manufacturing powder 1 to be newly fed, and even when these additive manufacturing powders 1 are mixed and used, the change in characteristics is small as compared with a case where these additive manufacturing powders 1 are not mixed. Therefore, by reusing the additive manufacturing powder 1, it is possible to reduce a used amount of the additive manufacturing powder 1 as a whole and to prevent deterioration of quality of the additively manufactured object 6. In addition, since a tolerance of humidity or the like at the time of reuse is increased, handling is facilitated. As a result, a production cost of the additively manufactured object 6 can be reduced, and an environmental load can be reduced.

In addition, in the additive manufacturing powder 1 according to the embodiment, it is preferable that the water amount is within the range even after the heat treatment is performed a plurality of times. Accordingly, since the change in hygroscopic property can be reduced even in a high-temperature environment and a high-humidity environment, the additive manufacturing powder 1 can be reused without managing the number of times of use. The plurality of times is, for example, three times.

When measuring the water amount of the additive manufacturing powder 1 before and after the heat treatment, the additive manufacturing powder 1 to be measured is left in an environment of a temperature of 25° C. and a relative humidity of 50% for 1 hour or longer, and then the measurement is performed.

The water amount before the heat treatment is preferably 150 ppm or less, more preferably 10 ppm or more and 120 ppm or less, and still more preferably 30 ppm or more and 100 ppm or less. When the water amount of the additive manufacturing powder 1 is within the above range, the additive manufacturing powder 1 is particularly difficult to aggregate. Therefore, the fluidity and the filling property of the additive manufacturing powder 1 can be particularly improved. In addition, rusting of the metal particles 11 due to the moisture can also be prevented, and thus the high-quality additively manufactured object 6 can be obtained. The water amount before the heat treatment may be less than the lower limit value, but in this case, a difficulty in producing and storing the additive manufacturing powder 1 may increase.

For the measurement of the water amount performed by the Karl Fischer method, for example, a moisture measuring device CA-310 manufactured by Nitto Seiko Analytech Co., Ltd. is used.

### 2.3.2. Contact Angle of Water

In addition, the additive manufacturing powder 1 according to the embodiment has a contact angle of water of 80° or more and 150° or less, which is measured in a state where the additive manufacturing powder 1 is spread in a layer form after being subjected to a heat treatment at 200° C. for 24 hours in an air atmosphere.

The additive manufacturing powder 1 showing such a contact angle of water has a small average particle diameter and a large surface area, but is less likely to absorb moisture even in a high-temperature environment or a high-humidity environment and less likely to aggregate, and is thus a powder having high fluidity. Therefore, even when such an additive manufacturing powder 1 is reused or exposed to a high-temperature environment or a high-humidity environment, the additive manufacturing powder 1 has excellent filling property, and thus contributes to improvement in mechanical strength and dimensional accuracy of the additively manufactured object 6. Accordingly, the additively manufactured object 6 which can be used to produce a metal sintered body and which is excellent in mechanical strength and dimensional accuracy is obtained.

In addition, the additive manufacturing powder 1 having a contact angle of water within the above range has excellent affinity with the binder solution 4. Therefore, when the binder solution 4 is supplied after the additive manufacturing powder 1 is spread to form the powder layer 31, the binder solution 4 easily permeates the formation region 60 of the powder layer 31. Accordingly, the binder solution 4 can uniformly permeate the formation region 60, so that the additively manufactured object 6 having high dimensional accuracy can be produced.

The contact angle of water in the additive manufacturing powder 1 can be measured by the following procedure. First, the additive manufacturing powder 1 is subjected to a heat treatment at 200° C. for 24 hours in an air atmosphere. Next, a double-sided tape is attached to a flat surface. Next, the additive manufacturing powder 1 subjected to the heat treatment is spread on the double-sided tape. As the double-sided tape, for example, a polyester adhesive tape No. 31B manufactured by Nitto Denko Corporation and having a total thickness of 0.080 mm type is used. Then, the spread additive manufacturing powder 1 is lightly pressed by a plate-shaped member. Next, the extra additive manufacturing powder 1 is blown off with an air blower. Accordingly, a test piece for the contact angle measurement is obtained. Examples of the air blower include a manual air blower used for cleaning a camera or the like. Then, a tip end of the air blower is fixed to a position 3 cm away from the test piece and the test piece is blown three times.

Next, a contact angle of water of the test piece is measured by a θ/2 method using a contact angle measuring device, Drop Master 500, manufactured by Kyowa Interface Science Co., Ltd. Measurement conditions include a temperature of 25° C. and a relative humidity of 50%±5%. In addition, a dropping amount of water is set to 3 μL, and the measurement is performed 5 seconds after drop adhesion.

The contact angle of water measured for the additive manufacturing powder 1 spread in the layer form is 80° or more and 150° or less as described above, preferably 95° or more and 145° or less, and more preferably 110° or more and 140° or less. The contact angle of water may exceed the upper limit value, but in this case, the hydrophobicity is too high, and thus permeability of the binder solution 4 may decrease depending on the composition of the binder solution 4. Accordingly, homogeneity of the additively manufactured object 6 may be reduced.

### 2.3.3. Average Particle Diameter

An average particle diameter of the additive manufacturing powder 1 according to the embodiment is 3.0 μm or more and 30.0 μm or less, preferably 4.0 μm or more and 15.0 μm or less, and more preferably 5.0 μm or more and 10.0 μm or less. By setting the average particle diameter of the additive manufacturing powder 1 within the above range, the additively manufactured object 6 having good surface roughness and high dimensional accuracy can be obtained.

The average particle diameter of the additive manufacturing powder 1 is obtained based on an integrated distribution curve obtained by measuring a volume-based particle size distribution by, for example, a laser diffraction method. Specifically, in the integrated distribution curve, a particle diameter D50 at which a cumulative value is 50% from a small diameter side is the average particle diameter. Examples of a measuring device include Microtrac HRA 9320-X100 manufactured by Nikkiso Co., Ltd.

### 2.3.4. Particle Size Distribution

For the additive manufacturing powder 1 according to the embodiment, when the volume-based particle size distribution is measured by the laser diffraction method to obtain the integrated distribution curve, a particle diameter at which the cumulative value is 10% from the small diameter side in the obtained integrated distribution curve is defined as D10, and a particle diameter at which the cumulative value is 90% from the small diameter side is defined as D90. At this time, (D90−D10)/D50 of the additive manufacturing powder 1 is preferably 1.0 or more and 2.7 or less, and more preferably 1.2 or more and 2.4 or less. (D90−D10)/D50 is an index indicating a degree of spread of the particle size distribution, and when this index is within the above range, the filling property of the additive manufacturing powder 1 is particularly favorable.

### 2.3.5. Bulk Density and Tap Density

When a bulk density is measured after the additive manufacturing powder 1 according to the embodiment is subjected to a heat treatment at 200° C. for 24 hours in an air atmosphere, a change from before the heat treatment is preferably prevented. Specifically, when the bulk density before the heat treatment is set to 1, the bulk density after the heat treatment is preferably 0.98 or more and 1.02 or less, and more preferably 0.99 or more and 1.01 or less. Accordingly, when the additive manufacturing powder 1 that is not bound in the above-described additive manufacturing method is reused, the decrease in fluidity due to heating is sufficiently prevented. As a result, even when the reused additive manufacturing powder 1 and the newly added additive manufacturing powder 1 are mixed, a difference in fluidity between these two additive manufacturing powders 1 can be reduced. Therefore, the additive manufacturing powder 1 in which the change in bulk density before and after the heat treatment is within the above range is suitable for reuse.

In addition, in the additive manufacturing powder 1 according to the embodiment, it is preferable that the bulk density is within the range even after the heat treatment is performed a plurality of times. Accordingly, since the change in fluidity can be reduced even in a high-temperature environment and a high-humidity environment, the additive manufacturing powder 1 can be reused without managing the number of times of use. The plurality of times is, for example, three times.

The bulk density of the additive manufacturing powder 1 is measured by a method for measuring an apparent density of metal powders specified in JIS Z2504:2012. Before the measurement, the additive manufacturing powder 1 to be measured is preferably left in an environment at a temperature of 25° C. and a relative humidity of 50% for 1 hour or longer.

When a tap density is measured after the additive manufacturing powder 1 according to the embodiment is subjected to a heat treatment at 200° C. for 24 hours in an air atmosphere, a change from before the heat treatment is preferably prevented. Specifically, when the tap density before the heat treatment is set to 1, the tap density after the heat treatment is preferably 0.94 or more and 1.06 or less, and more preferably 0.97 or more and 1.03 or less. In a case where such conditions are satisfied, when the additive manufacturing powder 1 that is not bound in the above-described additive manufacturing method is reused, the decrease in fluidity due to heating is sufficiently prevented. As a result, even when the reused additive manufacturing powder 1 and the newly added additive manufacturing powder 1 are mixed, a difference in fluidity between these two additive manufacturing powders 1 can be reduced. Therefore, the additive manufacturing powder 1 in which the change in tap density before and after the heat treatment is within the above range is suitable for reuse.

In addition, in the additive manufacturing powder 1 according to the embodiment, it is preferable that the tap density is within the range even after the heat treatment is performed a plurality of times. Accordingly, since the change in fluidity can be reduced even in a high-temperature environment and a high-humidity environment, the additive manufacturing powder 1 can be reused without managing the number of times of use. The plurality of times is, for example, three times.

The tap density of the additive manufacturing powder 1 is measured by Powder Tester (registered trademark) PT-X, which is a powder characteristic evaluation device and manufactured by Hosokawa Micron Corporation. Before the measurement, the additive manufacturing powder 1 to be measured is preferably left in an environment at a temperature of 25° C. and a relative humidity of 50% for 1 hour or longer.

### 2.3.6. Bending Stress of Additively Manufactured Object

In the additive manufacturing powder 1 according to the embodiment, when additive manufacturing is performed using a water-soluble resin as the binder, a bending stress of the obtained additively manufactured object is preferably 15 N/cm² (0.15 MPa) or more, and more preferably 20 N/cm² (0.20 MPa) or more. With such an additive manufacturing powder 1, an additively manufactured object having a sufficiently high bending stress can be produced. Accordingly, for example, mechanical strength of a metal sintered body obtained by sintering the additively manufactured object can be increased. In addition, in the case where the mechanical strength of the obtained metal sintered body is sufficiently high and there is no need to further improve the mechanical strength, a used amount of the binder at the time of manufacturing the additively manufactured object can be reduced. Accordingly, it is possible to reduce a shrinkage amount of the additively manufactured object in debindering and sintering. As a result, the dimensional accuracy of the metal sintered body obtained by sintering the additively manufactured object can be improved. The used amount of the binder in the additively manufactured object whose bending stress is to be measured is 70 mass % of a used amount of the additive manufacturing powder 1.

A shape of the additively manufactured object for obtaining the bending stress is a rectangular parallelepiped shape having a length of 40 mm, a width of 20 mm, and a thickness of 6.6 mm. In addition, the binder jet method is used for the method for producing an additively manufactured object, and a polyvinyl alcohol aqueous solution is used as the binder solution.

### 2.3.7. Concentration of Hydroxy Group

Each particle (surface-coated particle 13) of the additive manufacturing powder 1 according to the embodiment is coated with the compound derived from the coupling agent having a hydrophobic functional group as described above. On the other hand, on the surface of the metal particle 11, there are many binding sites at which moisture in the air can be bounded as a hydroxy group. Therefore, when the surface of the metal particle 11 is coated with the compound derived from the coupling agent, a concentration at the binding site decreases. As a result, the concentration of the hydroxy group is reduced on the surface of the surface-coated particle 13, and the hygroscopic property is stabilized.

The concentration of the hydroxy group can be quantified by the following method. In the following method, a silane coupling agent is used as the coupling agent.

First, 0.01 g of the additive manufacturing powder 1 is collected in a glove box. Then, the collected additive manufacturing powder 1 and 100 μL of 2,2,2-trifluoroethanol (trifluoroalcohol) are charged into a container which can be sealed, followed by sealing. Accordingly, 2,2,2-trifluoroethanol is bound to the hydroxy group in the additive manufacturing powder 1 sealed in the container.

Next, the sealed container is charged into a thermostatic tank at 80° C. and left for 20 hours.

Next, the container is open on a hot plate set at 80° C., and the additive manufacturing powder 1 is taken out.

Next, the taken-out additive manufacturing powder 1 is set in an X-ray photoelectron spectrometer. Then, an XPS spectrum is acquired by a wide scan, and a Si2p peak and an F1s peak are identified.

Next, each peak area of the Si2p peak and the F1s peak in the XPS spectrum is calculated using analysis software. The peak area of the Si2p peak corresponds to a concentration of Si in the additive manufacturing powder 1 at an analysis depth. The peak area of the F1s peak corresponds to a concentration of the hydroxy group in the additive manufacturing powder 1 at an analysis depth. When the peak area of the Si2p peak is set to 1, a ratio of the peak area of the F1s peak is calculated. Accordingly, a relative value of the concentration of the hydroxy group when the concentration of Si is set to 1 is calculated.

In the additive manufacturing powder 1 according to the embodiment, the relative value of the concentration of the hydroxy group calculated by the above-described method is preferably 0.40 or less, more preferably 0.30 or less, and still more preferably 0.20 or less. In such an additive manufacturing powder 1, since the concentration of the hydroxy group is prevented to be sufficiently low, the change in hygroscopic property can be particularly reduced even in a high-temperature environment and a high-humidity environment. Therefore, such an additive manufacturing powder 1 has a particularly little change in characteristics such as fluidity, and is suitable for reuse. A lower limit value of the relative value is not particularly set, and may be set to 0.05. When the relative value is less than the lower limit value, it may be difficult to stably produce the additive manufacturing powder 1.

A concentration of the hydroxy group in the additive manufacturing powder 1 can be adjusted according to, for example, an amount of the coupling agent to be reacted with the metal particles 11 and functionality of a hydrolyzable group. Specifically, when the amount of the coupling agent or the functionality of the hydrolyzable group is increased, the concentration of the hydroxy group tends to decrease. In contrast, when the amount of the coupling agent or the functionality of the hydrolyzable group is reduced, the concentration of the hydroxy group tends to increase.

On the other hand, even when the metal particles 11 are used instead of the additive manufacturing powder 1, the relative value of the concentration of the hydroxy group can be calculated by the above-described method. In the metal particles 11, the relative value of the concentration of the hydroxy group calculated by the above-described method is preferably more than 0.40, more preferably 0.50 or more, and still more preferably 0.55 or more. In such metal particles 11, since the concentration of the hydroxy group is sufficiently high, the coupling agent can be bound with a high density. As a result, a density of the hydrophobic functional group to be introduced can be increased, and the additive manufacturing powder 1 having stable hydrophobicity can be obtained. An upper limit value of the relative value is not particularly set, and may be set to 0.90. When the relative value exceeds the upper limit value, it may be difficult to stably produce the metal particles 11.

### 3. Effects of Embodiment

As described above, the additive manufacturing powder 1 includes the metal powder, and the films 12 provided on the surfaces of the particles (metal particles 11) of the metal powder. The films 12 contain the compound derived from the coupling agent having a hydrophobic functional group.

The average particle diameter of the additive manufacturing powder 1 is 3.0 μm or more and 30.0 μm or less. The water amount is measured by the Karl Fischer method before and after the additive manufacturing powder 1 is subjected to a heat treatment at 200° C. for 24 hours in an air atmosphere, and when the water amount before the heat treatment is set to 1, the water amount after the heat treatment is 0.85 or more and 1.15 or less in terms of mass ratio.

Such an additive manufacturing powder 1 has a small average particle diameter and a large surface area, but the change in hygroscopic property can be reduced even in a high-temperature environment or a high-humidity environment. Therefore, even when such an additive manufacturing powder 1 is not used once when subjected to additive manufacturing and remains, there is little change in characteristics such as fluidity and it is suitable for reuse. Accordingly, it is possible to reduce the used amount of the additive manufacturing powder 1 as a whole and to prevent the deterioration of the quality of the additively manufactured object 6. As a result, the production cost of the additively manufactured object 6 can be reduced, and the environmental load can be reduced.

In addition, the hydrophobic functional group is preferably a cyclic structure-containing group, a fluoroalkyl group, or a fluoroaryl group. These hydrophobic functional groups give not only hydrophobicity but also heat resistance to the film 12. Accordingly, it is possible to obtain the additive manufacturing powder 1 which maintains the hydrophobicity even in a high-temperature environment, which is less likely to absorb moisture, and which is less likely to have decreased fluidity.

The tap density is measured before and after the additive manufacturing powder 1 is subjected to a heat treatment at 200° C. for 24 hours in an air atmosphere, and when the tap density before the heat treatment is set to 1, the tap density after the heat treatment is 0.94 or more and 1.06 or less. In a case where such conditions are satisfied, when the additive manufacturing powder 1 that is not bound in the above-described additive manufacturing method is reused, the decrease in fluidity due to heating is sufficiently prevented. As a result, even when the reused additive manufacturing powder 1 and the newly added additive manufacturing powder 1 are mixed, a difference in fluidity between these two additive manufacturing powders 1 can be reduced.

The film 12 is preferably a monomolecular film made of the above-described compound. The thickness of the film 12 that is the monomolecular film can be minimized. As a result, it is possible to obtain the additively manufactured object 6 in which an occupancy of the films 12 is low and an occupancy of the metal particles 11 is high.

In addition, the additive manufacturing powder 1 has a contact angle of water of 80° or more and 150° or less, which is measured at 25° C. by a θ/2 method in the state where the additive manufacturing powder 1 is spread in a layer form after being subjected to a heat treatment at 200° C. for 24 hours in an air atmosphere.

Such an additive manufacturing powder 1 is less likely to absorb the moisture even in a high-temperature environment or a high-humidity environment and less likely to aggregate, and thus has high fluidity. Therefore, such an additive manufacturing powder 1 is particularly suitable for reuse. In addition, the additive manufacturing powder 1 having a contact angle of water within the above range has excellent affinity with the binder solution 4. Therefore, the binder solution 4 easily permeates the formation region 60 of the powder layer 31, and the additively manufactured object 6 having high dimensional accuracy can be produced. According to such an additively manufactured object 6, for example, a metal sintered body excellent in mechanical strength and dimensional accuracy can be produced.

The coupling agent may be a silane coupling agent. In this case, when the concentration of the hydroxy group in the additive manufacturing powder 1 measured by X-ray photoelectron spectroscopy is calculated as a relative value with the concentration of Si being set to 1, the relative value is preferably 0.40 or less.

In such an additive manufacturing powder 1, since the concentration of the hydroxy group is prevented to be sufficiently low, the change in hygroscopic property can be particularly reduced even in a high-temperature environment and a high-humidity environment. Therefore, such an additive manufacturing powder 1 has a particularly little change in characteristics such as fluidity, and is suitable for reuse.

The additively manufactured object 6 contains the additive manufacturing powder 1 and the binder that binds the particles of the additive manufacturing powder 1 together. Such an additively manufactured object 6 has high dimensional accuracy and high mechanical strength due to benefits of high fluidity and filling property of the additive manufacturing powder 1. Therefore, for example, a metal sintered body having high dimensional accuracy and mechanical strength can be obtained by sintering such an additively manufactured object 6.

### 4. Method for Producing Additive Manufacturing Powder

Next, a method for producing the additive manufacturing powder will be described.

FIG. 12 is a step diagram showing the method for producing the additive manufacturing powder. The method for producing the additive manufacturing powder shown in FIG. 12 includes a preparation step S202, a coupling agent reaction step S204, and a heating step S206.

### 4.1. Preparation Step

In the preparation step S202, the metal powder containing the metal particles 11 is prepared. The metal particles 11 may be produced by any method, are preferably produced by an atomizing method such as a water atomizing method, a gas atomizing method, or a rotating water flow atomizing method, and are more preferably produced by a water atomizing method or a rotating water flow atomizing method. The surfaces of the metal particles 11 produced by these methods are likely to be covered with a water-derived hydroxy group. Therefore, adhesion of the film 12 and the concentration of the hydrophobic functional group can be increased, and the water amount in the additive manufacturing powder 1 can be reduced. Accordingly, even when the film 12 is thin, the fluidity of the surface-coated particles 13 can be sufficiently increased. As a result, the additively manufactured object 6 having a higher occupancy of the metal particles 11 than the occupancy of the films 12 and a smaller shrinkage rate during sintering can be obtained.

### 4.2. Coupling Agent Reaction Step

In the coupling agent reaction step S204, the coupling agent having a hydrophobic functional group is reacted with the metal powder. Accordingly, the coupling agent adheres to the surfaces of the metal particles 11. Examples of this operation include the following three operations.

In a first operation, both the metal particles 11 and the coupling agent are charged into a chamber, and then an inside of the chamber is heated.

In a second operation, the metal particles 11 are charged into a chamber, and then the coupling agent is sprayed into the chamber while stirring the metal particles 11.

In a third operation, water, a coupling agent, and an alkaline solution of ammonia or sodium hydroxide are charged into a primary alcohol such as methanol, ethanol, and isopropyl alcohol, followed by stirring, filtration, and then drying.

Examples of the coupling agent include a silane coupling agent, a titanium coupling agent, and a zirconium coupling agent.

The following chemical formula is an example of a molecular structure of the silane coupling agent.

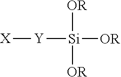

In the above formula, X is a functional group, Y is a spacer, and OR is a hydrolyzable group. R is, for example, a methyl group or an ethyl group.

Examples of the spacer include an alkylene group, an arylene group, an aralkylene group, and an alkylene ether group.

Examples of the hydrolyzable group include an alkoxy group, a halogen atom, a cyano group, an acetoxy group, and an isocyanate group, and among these, in a case of an alkoxy group, silanol is produced by hydrolysis. The silanol reacts with the hydroxy group generated on the surface of the metal particle 11, and the coupling agent adheres to the surface of the metal particle 11.

At least one such hydrolyzable group may be contained in the coupling agent, and it is preferable that two or more such alkoxy groups are contained, and it is more preferable that three such hydrolyzable groups are contained as in the above formula. For example, the coupling agent in which the hydrolyzable group is an alkoxy group preferably contains a dialkoxy group, and more preferably a trialkoxy group. The coupling agent containing a trialkoxy group (coupling agent containing three hydrolyzable groups) reacts with three hydroxy groups generated on the surface of the metal particle 11. Therefore, the film 12 derived from the coupling agent has good adhesion to the metal particle 11. Since the coupling agent containing a trialkoxy group is also excellent in film forming property, it is possible to obtain the film 12 having excellent continuity. Such a film 12 contributes to further increasing the fluidity of the additive manufacturing powder 1.

In the coupling agent containing a trialkoxy group, even when the hydrophobic functional group is thermally decomposed after the film 12 is formed, the remaining part can continue to cover the surface of the metal particle 11. Therefore, a decrease in hydrophobicity can be prevented.

As described above, examples of the hydrophobic functional group contained in the coupling agent include a cyclic structure-containing group, a fluoroalkyl group, and a fluoroaryl group.

Among these, as described above, examples of the coupling agent having a cyclic structure-containing group include a coupling agent having an aromatic hydrocarbon group and a coupling agent having a cyclic ether group.

Examples of the coupling agent having an aromatic hydrocarbon group include: phenyltrimethoxysilane represented by the following formula (A-1),

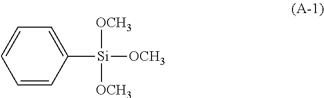 [SMILES: CO[Si](OC)(OC)c1ccccc1]

phenyltriethoxysilane represented by the following formula (A-2),

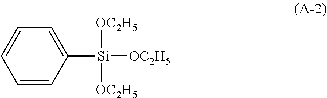 [SMILES: CCO[Si](OCC)(OCC)c1ccccc1]

dimethoxydiphenylsilane represented by the following formula (A-3),

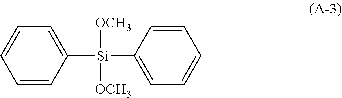 [SMILES: CO[Si](OC)(c1ccccc1)c1ccccc1]

2,2-dimethoxy-1-phenyl-1-aza-2-silacyclopentane represented by the following formula (A-4),

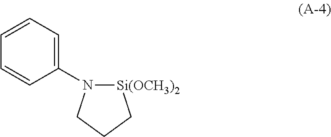

3-phenoxypropyltrichlorosilane represented by the following formula (A-11),

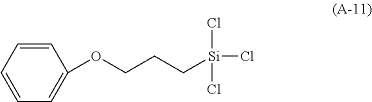 [SMILES: Cl[Si](Cl)(Cl)CCCOc1ccccc1]

phenyltriacetoxysilane represented by the following formula (A-12),

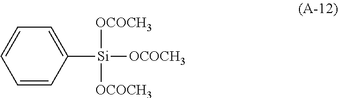

triethoxy(p-tolyl)silane represented by the following formula (A-13),

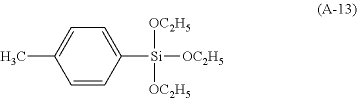 [SMILES: CCO[Si](OCC)(OCC)c1ccc(C)cc1]

p-aminophenyltrimethoxysilane represented by the following formula (A-14),

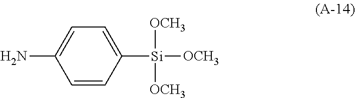 [SMILES: CO[Si](OC)(OC)c1ccc(N)cc1]

m-aminophenyltrimethoxysilane represented by the following formula (A-15), and

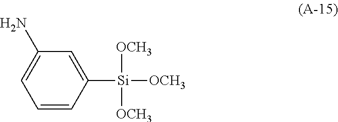 [SMILES: CO[Si](OC)(OC)c1cccc(N)c1]

((chloromethyl)phenylethyl)trimethoxysilane represented by the following formula (A-16),

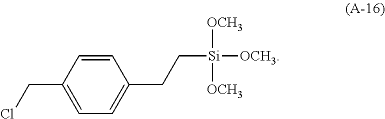 [SMILES: CO[Si](CCc1ccc(CCl)cc1)(OC)OC]

Examples of the coupling agent having a cyclic ether group include: 3-glycidoxypropylmethyldimethoxysilane represented by the following formula (A-5),

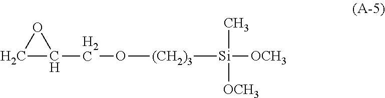

3-glycidoxypropyltrimethoxysilane represented by the following formula (A-6),

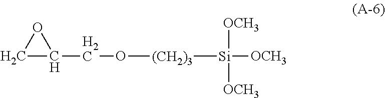

3-glycidoxypropylmethyldiethoxysilane represented by the following formula (A-7), and

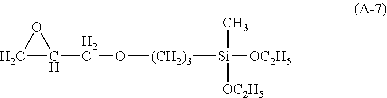

3-glycidoxypropyltriethoxysilane represented by the following formula (A-8)

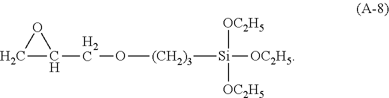

Examples of the coupling agent having a fluoroalkyl group include: trimethoxy(3,3,3-trifluoropropyl)silane represented by the following formula (B-1),

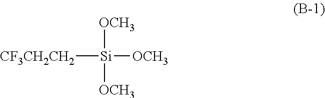

trimethoxy(1H,1H,2H,2H-tridecafluoro-n-octyl)silane represented by the following formula (B-2), and

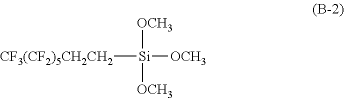

trimethoxy(1H,1H,2H,2H-nonafluorohexyl)silane represented by the following formula (B-3)

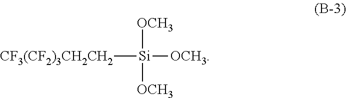

Examples of the coupling agent having a fluoroaryl group include: trimethoxy(11-pentafluorophenoxyundecyl)silane represented by the following formula (C-1), and

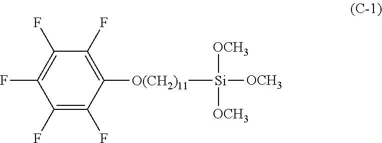

pentafluorophenyldimethylchlorosilane represented by the following formula (C-2)

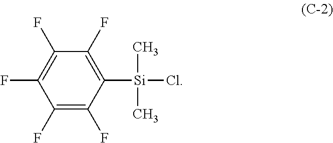

An adding amount of the coupling agent is not particularly limited, and is preferably 0.01 mass % or more and 1.00 mass % or less, and more preferably 0.05 mass % or more and 0.50 mass % or less, with respect to the metal particles 11.

The coupling agent is supplied by a method such as standing in a chamber and spraying into a chamber.

### 4.3. Heating Step

In the heating step S206, the metal particles 11 to which the coupling agent adheres are heated. Accordingly, the films 12 are formed on the surfaces of the metal particles 11, and the additive manufacturing powder 1 is obtained. By heating, the unreacted coupling agent can be removed.

A heating temperature of the metal particles 11 to which the coupling agent adheres is not particularly limited, and is preferably 50° C. or higher and 300° C. or lower, and more preferably 100° C. or higher and 250° C. or lower. A heating time is preferably 10 minutes or longer and 24 hours or shorter, and more preferably 30 minutes or longer and 10 hours or shorter. Examples of an atmosphere in the heat treatment include an air atmosphere and an inert gas atmosphere.

In the above, the additive manufacturing powder and the additively manufactured object according to the present disclosure are described based on the illustrated embodiment, but the present disclosure is not limited thereto, and for example, the additive manufacturing powder and the additively manufactured object according to the present disclosure may be those to which any component is added to the above-described embodiment. Any film may be provided between the metal particles and the film or on the surface of the film.

### EXAMPLES

Next, specific Examples of the present disclosure will be described.

### 5. Production of Additive Manufacturing Powder

### 5.1. Example 1

First, a powder of precipitation hardening stainless steel 17-4PH produced by a water atomizing method was prepared. Then, 100 g of the prepared metal powder was pretreated. Next, a coupling agent and water were mixed to prepare a solution, and then this solution was heated to 200° C. and sprayed onto the metal powder by spray coating. Then, the metal powder sprayed with the solution was dried. A used amount of the coupling agent was 0.1 mass % of the metal powder. As described above, an additive manufacturing powder was obtained. The film of the obtained additive manufacturing powder was a monomolecular film.

### 5.2. Examples 2 to 6

Additive manufacturing powders were obtained in the same manner as in Example 1 except that production conditions for the additive manufacturing powders were changed as shown in Table 1. The particle diameter D50 of the used metal powder was 3 μm to 15 μm.

### 5.3. Examples 7 to 10

Additive manufacturing powders were obtained in the same manner as in Example 1 except that an amount of the coupling agent was changed to adjust the water amount and the concentration of the hydroxy group to values shown in Table 1.

### 5.4. Comparative Examples 1 to 7

Additive manufacturing powders were obtained in the same manner as in Example 1 except that production conditions for the additive manufacturing powders were changed as shown in Table 1. The particle diameter D50 of the used metal powder was 3 μm to 15 μm. Symbols of chemical formulas shown in Table 1 correspond to the following compounds.
D-1: methyltrimethoxysilane
D-2: propyltrimethoxysilane
D-3: decyltrimethoxysilane
D-4: octadecyltrimethoxysilane
D-5: vinyltrimethoxysilane
D-6: aminotrimethoxysilane

### 6. Acquisition of Characteristics of Additive Manufacturing Powder and Additively Manufactured Object

### 6.1. Water Amount Before and After Heat Treatment

The obtained additive manufacturing powder was subjected to a heat treatment, and the water amounts before and after the heat treatment were measured by a Karl Fischer method. The water amount before the heat treatment was set to 1, and the relative value of the water amount after the heat treatment was calculated. A calculation result is shown in Table 1.

### 6.2. Concentration of Hydroxy Group

For the obtained additive manufacturing powder, the concentration of the hydroxy group was calculated as the relative value to the concentration of Si. A calculation result is shown in Table 1.

The concentration of the hydroxy group in the metal particles used in the production of the additive manufacturing powders was calculated to be within a range of 0.56 to 0.66.

### 6.3. Particle Size Distribution

The particle diameters D10, D50, and D90 of the obtained additive manufacturing powder were obtained. The particle diameter D50 was 7 μm. Then, (D90−D10)/D50 was calculated. The calculated (D90−D10)/D50 is shown in Table 1.

### 6.4. Contact Angle of Water Before and After Heat Treatment

The obtained additive manufacturing powder was spread in a layer form to prepare a test piece, and then the contact angle of water was measured for the test piece. Then, the measured value was classified into any one of A to D based on the following classification criteria.
A: The contact angle is 110° or more and 150° or less.
B: The contact angle is 95° or more and less than 110°.
C: The contact angle is 80° or more and less than 95°.
D: The contact angle is less than 80°.

The classification results are shown as “contact angle of water before heat treatment” in Table 1. Pure water was used as water, and the measurement temperature was 25° C.

Next, the additive manufacturing powder was subjected to a heat treatment at 200° C. for 24 hours in an air atmosphere. Next, the additive manufacturing powder subjected to the heat treatment was spread in a layer form to prepare a test piece, and then the contact angle of water was measured for the test piece again. Then, the measured value was classified into any one of A to D based on the above classification criteria. The classification results are shown as “contact angle of water after heat treatment” in Table 1.

TABLE 1

| | Configuration of additive manufacturing powder | | | | | | | | | |
|---|---|---|---|---|---|---|---|---|---|---|
| | | Coupling agent | | | Before heat treatment | | | | After heat treatment | |
| | | Functional | Hydrolyzable | | Water | Concentration of | (D90 − | Contact | Relative value of | Contact |
| | Film | group | group | Chem. | amount | hydroxy group | D10)/D50 | angle | water amount | angle |
| | — | — | — | — | ppm | — | — | — | — | — |
| Example 1 | Yes | Phenyl group | Trimethoxy group | A-1 | 60 | 0.13 | 1.3 | A | 0.97 | A |
| Example 2 | Yes | Phenyl group | Triethoxy group | A-2 | 60 | 0.14 | 1.4 | A | 0.96 | A |
| Example 3 | Yes | Phenyl group | Dimethoxy group | A-3 | 120 | 0.28 | 1.8 | A | 0.94 | B |
| Example 4 | Yes | Epoxy group | Trimethoxy group | A-6 | 100 | 0.24 | 1.5 | A | 0.95 | C |
| Example 5 | Yes | Fluoroalkyl group | Trimethoxy group | B-1 | 50 | 0.11 | 1.2 | A | 0.99 | A |
| Example 6 | Yes | Fluorophenyl group | Trimethoxy group | C-1 | 50 | 0.09 | 1.1 | A | 0.99 | A |
| Example 7 | Yes | Phenyl group | Trimethoxy group | A-1 | 30 | 0.05 | 1.3 | A | 0.99 | A |
| Example 8 | Yes | Phenyl group | Trimethoxy group | A-1 | 90 | 0.15 | 1.3 | A | 0.99 | A |
| Example 9 | Yes | Phenyl group | Trimethoxy group | A-1 | 120 | 0.24 | 1.3 | B | 0.91 | B |
| Example 10 | Yes | Phenyl group | Trimethoxy group | A-1 | 150 | 0.32 | 1.3 | C | 0.87 | C |
| Comparative | No | — | — | — | 180 | 0.61 | 2.2 | D | 1.05 | D |
| Example 1 | | | | | | | | | | |
| Comparative | Yes | Methyl group | Trimethoxy group | D-1 | 120 | 0.31 | 1.6 | A | 0.78 | D |
| Example 2 | | | | | | | | | | |
| Comparative | Yes | Propyl group | Trimethoxy group | D-2 | 100 | 0.25 | 1.8 | A | 0.81 | D |
| Example 3 | | | | | | | | | | |
| Comparative | Yes | Decyl group | Trimethoxy group | D-3 | 60 | 0.14 | 1.9 | A | 0.83 | D |
| Example 4 | | | | | | | | | | |
| Comparative | Yes | Octadecyl group | Trimethoxy group | D-4 | 60 | 0.15 | 2.0 | A | 0.84 | D |
| Example 5 | | | | | | | | | | |
| Comparative | Yes | Vinyl group | Trimethoxy group | D-5 | 100 | 0.26 | 1.6 | A | 0.81 | D |
| Example 6 | | | | | | | | | | |
| Comparative | Yes | Amino group | Trimethoxy group | D-6 | 120 | 0.29 | 1.9 | A | 0.79 | D |
| Example 7 | | | | | | | | | | |

### 7. Evaluation on Additive Manufacturing Powder

Hereinafter, various evaluations on the additive manufacturing powders of Examples and Comparative Examples will be described, and in the following description, the additive manufacturing powder is also simply referred to as a “powder”.

### 7.1. Filling Property Before and After Heat Treatment

In a 50 mL screw cap bottle was charged 50 g of the powder of each of Examples and Comparative Examples. Then, with the screw cap bottle being erected, a height from a bottom surface to a top surface of the powder was measured, and accordingly a filling property of the powder was evaluated. This filling property evaluation was performed based on the following evaluation criteria. Evaluation results are shown in Table 2.
A: The height is 25 mm or less.
B: The height exceeds 25 mm and is 30 mm or less.
C: The height exceeds 30 mm.

Next, the powder of each of Examples and Comparative Examples was subjected to a heat treatment at 200° C. for 24 hours in an air atmosphere. The filling property of the powder after the heat treatment was evaluated again. Evaluation results are shown in Table 2.

### 7.2. Tapping Property

In a 50 mL screw cap bottle was charged 50 g of the powder of each of Examples and Comparative Examples. Then, the screw cap bottle was struck on a desk for 10 times. Then, with the screw cap bottle being erected, a height from a bottom surface to a top surface of the powder was measured, and a tapping property of the powder was evaluated according to the height. This tapping property evaluation was performed based on the following evaluation criteria.
A: The height is 19 mm or less.
B: The height exceeds 19 mm and is 25 mm or less.
C: The height exceeds 25 mm.

Evaluation results are shown in Table 2.

### 7.3. Aggregation Property Before and After Heat Treatment

In a 50 mL screw cap bottle was charged 50 g of the powder of each of Examples and Comparative Examples. Then, the screw cap bottle was rotated for 10 times around an axis passing through a center of a bottom surface of the screw cap bottle. Then, an aggregation state of the powder was observed from an outside of the screw cap bottle, and accordingly an aggregation property of the powder was evaluated. This aggregation property evaluation was performed based on the following evaluation criteria.
A: With aggregation
C: No aggregation

Next, the powder of each of Examples and Comparative Examples was subjected to a heat treatment at 200° C. for 24 hours in an air atmosphere. The aggregation property of the powder after the heat treatment was evaluated again. The above evaluation results are shown in Table 2.

7.4. Change in Tap Density with Heat Treatment

The tap density of the powder of each of Examples and Comparative Examples was measured. Next, the powder of each of Examples and Comparative Examples was subjected to a heat treatment. Next, the tap density before the heat treatment was set to 1, and the relative value of the tap density after the heat treatment was calculated. Then, the calculated relative value was evaluated based on the following evaluation criteria. Evaluation results are shown in Table 2.
A: The relative value of the tap density is 0.97 or more and 1.03 or less.
B: The relative value of the tap density is 0.94 or more and less than 0.97, or more than 1.03 and 1.06 or less.
C: The relative value of the tap density is less than 0.94 or more than 1.06.

### 8. Evaluation on Additively Manufactured Object

### 8.1. Bending Stress

Using the powder of each of Examples and Comparative Examples, an additively manufactured object having a rectangular parallelepiped shape was prepared by a binder jet method. A size of the prepared additively manufactured object was 40 mm in length, 20 mm in width, and 5 mm in thickness. A polyvinyl alcohol aqueous solution is used as a binder solution.

Next, a bending load of the prepared additively manufactured object was measured using a three-point bending test instrument. Then, a bending stress o of the additively manufactured object was calculated according to the following equation.

$$σ = \frac{3 F L}{2 b {h}^{2}}$$

In the above equation, F is the bending load, L is a distance between fulcrums of the three-point bending test instrument, b is a width of the additively manufactured object, and h is a thickness of the additively manufactured object.

In addition, in the preparation of the additively manufactured object, additively manufactured objects in which the used amount of the binder was set to 70 mass % and 100 mass % of the metal powder were prepared, and the bending stress o was calculated for each of the additively manufactured objects. Calculation results are shown in Table 2.

### 8.2. Dimensional Accuracy

Using the powder of each of Examples and Comparative Examples, an additively manufactured object having a rectangular parallelepiped shape was prepared by a binder jet method. Next, dimensions of the additively manufactured object were measured. A deviation width from a target value of the dimension was calculated, and a ratio of the deviation width to the target value was defined as the dimensional accuracy. In addition, in the preparation of the additively manufactured object, additively manufactured objects in which the used amount of the binder was set to 70 mass %, 85 mass %, and 100 mass % of the metal powder were prepared, and the dimensional accuracy was calculated for each of the additively manufactured objects. Calculation results are shown in Table 2. In the dimensional accuracy, a negative value indicates that the dimension is smaller than the target value, and a positive value indicates that the dimension is larger than the target value.

TABLE 2

| | Evaluation result of additive manufacturing powder | | | | | | Evaluation result of additively manufactured object | | | | |
|---|---|---|---|---|---|---|---|---|---|---|---|
| | Before heat treatment | | | After heat treatment | | | Bending stress | | Dimensional accuracy | | |
| | Filling | Tapping | Aggregation | Filling | Aggregation | Change in | Used amount of binder | | Used amount of binder | | |
| | property | property | property | property | property | tap density | 70% | 100% | 70% | 85% | 100% |
| | — | — | — | — | — | — | N/cm² | N/cm² | % | % | % |
| Example 1 | A | A | A | A | A | A | 23 | 64 | −0.1 | 0 | 0.3 |
| Example 2 | A | A | A | A | A | A | 22 | 62 | −0.3 | 0.1 | 0.4 |
| Example 3 | A | A | A | A | A | A | 19 | 50 | −0.8 | 0.4 | 0.5 |
| Example 4 | A | A | A | B | A | B | 18 | 47 | −0.9 | 0.6 | 0.9 |
| Example 5 | A | A | A | A | A | A | 25 | 70 | −0.2 | −0.1 | 0.2 |
| Example 6 | A | A | A | A | A | A | 27 | 72 | −0.1 | 0 | 0.2 |
| Example 7 | A | A | A | A | A | A | 25 | 70 | −0.2 | 0 | 0.1 |
| Example 8 | A | A | A | A | A | A | 21 | 60 | −0.4 | 0.2 | 0.6 |
| Example 9 | A | A | A | A | A | B | 17 | 46 | −1.2 | 1.1 | 2.1 |
| Example 10 | A | A | A | B | A | B | 16 | 44 | −1.3 | 1.2 | 2.3 |
| Comparative | C | B | C | C | C | C | 11 | 20 | −3.4 | 3.4 | 4.1 |
| Example 1 | | | | | | | | | | | |
| Comparative | A | A | A | B | A | B | 13 | 36 | −2.5 | 2.4 | 3.5 |
| Example 2 | | | | | | | | | | | |
| Comparative | A | A | A | B | A | B | 14 | 40 | −2.3 | 2.2 | 3.2 |
| Example 3 | | | | | | | | | | | |
| Comparative | B | A | A | B | A | B | 15 | 41 | −1.8 | 1.7 | 2.6 |
| Example 4 | | | | | | | | | | | |
| Comparative | B | A | A | B | A | B | 16 | 42 | −1.6 | 1.5 | 2.4 |
| Example 5 | | | | | | | | | | | |
| Comparative | A | A | A | B | A | B | 13 | 35 | −1.5 | 1.4 | 2.3 |
| Example 6 | | | | | | | | | | | |
| Comparative | A | A | A | B | A | B | 12 | 32 | −2.3 | 2.1 | 3.2 |
| Example 7 | | | | | | | | | | | |

### 8.3. Consideration on Evaluation Results

As shown in Table 2, in the powder of each of Examples, when the water amount before the heat treatment was set to 1, the water amount after the heat treatment was within a predetermined range. In addition, in the powder of each of Examples, the changes in filling property and tap density were prevented before and after the heat treatment. The reason why such an effect is obtained is that, in the powder of each of Examples, the concentration of the hydroxy group is sufficiently prevented to be low by the film, and the film has good heat resistance, so that even after the heat treatment, the change in hygroscopic property from before the heat treatment is small. Therefore, the powder of each of Examples exhibits substantially the same fluidity as that of the new powder even when the powder is used for reuse, and thus can be evaluated as suitable for reuse. Although not shown in Tables 1 and 2, the additive manufacturing powders produced using metal particles having a particle diameter D50 of 3 μm and 15 μm also showed the same evaluation results as in Table 2.

In addition, as shown in Table 2, the powder of each of Examples had a better tapping property than the powder of each of Comparative Examples. Further, it was confirmed that the powder of each of Examples had a contact angle of water within a predetermined range and maintained good hydrophobicity even after the heat treatment. Therefore, it can be evaluated that even when the powder of each of Examples is used for reuse, a state where the moisture absorption is difficult is maintained.

In addition, it was found that, by using the powder of each of Examples, it is possible to prepare an additively manufactured object having a large bending stress and high dimensional accuracy. Further, in the powder of each of Examples, even when the used amount of the binder was reduced, the decrease in bending stress and dimensional accuracy was small as compared with the powder of each of Comparative Examples.

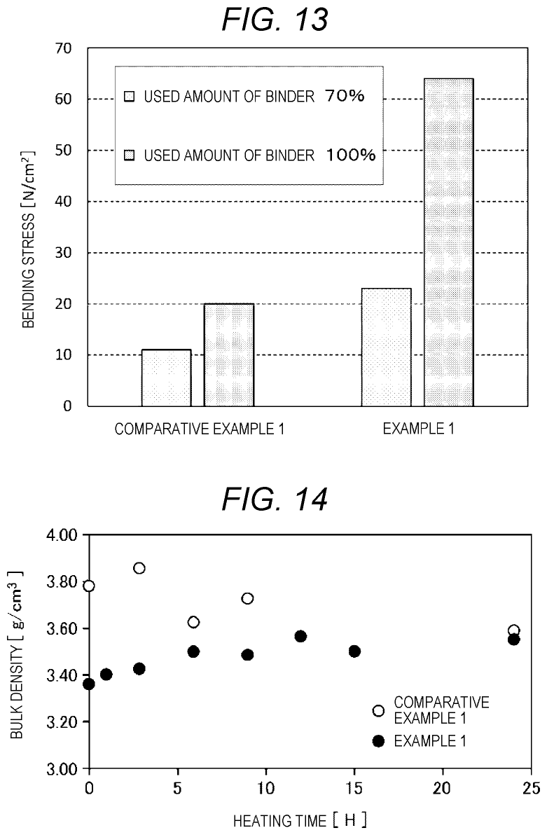

Here, FIG. 13 shows a graph of comparative results of the bending stress of the additively manufactured object prepared using the powder in Example 1 and the bending stress of the additively manufactured object prepared using the powder in Comparative Example 1 among measurement results of bending stresses shown in Table 2.

As shown in FIG. 13, the bending stress of the additively manufactured object prepared using the additive manufacturing powder in Example 1 was higher than the bending stress of the additively manufactured object prepared using the additive manufacturing powder in Comparative Example 1 even when the used amount of the binder was reduced to 70%. Therefore, in the additive manufacturing powder of each of Examples, it is possible to reduce the used amount of the binder while maintaining the bending stress of the additively manufactured object.

While a time of the heat treatment described above was changed, a change in bulk density of the powder was measured. Results are shown in FIG. 14. FIG. 14 is a graph showing a relationship between the heating time and each bulk density of the powder in Example 1 and the powder in Comparative Example 1, where a horizontal axis represents a time of the heat treatment (heating time) and a vertical axis represents the bulk density.

As shown in FIG. 14, in the powder in Example 1, even when the treatment time of the heat treatment is long, the decrease in bulk density is prevented. Therefore, it can be seen that in the powder in Example 1, the fluidity does not easily decrease even when the powder placed in a high-temperature environment is repeatedly reused. In contrast, since the bulk density of the powder in Comparative Example 1 decreases depending on the heating time, it can be seen that the fluidity thereof easily decreases when the powder is placed in a high-temperature environment. The powders in other Examples and the powders in other Comparative Examples showed the same tendency as the powder in Example 1 and the powder in Comparative Example 1, respectively.

The powder in Example 1 and the powder in Comparative Example 1 were further subjected to the heat treatment twice. Then, the water amount and the tap density after each heat treatment were measured.

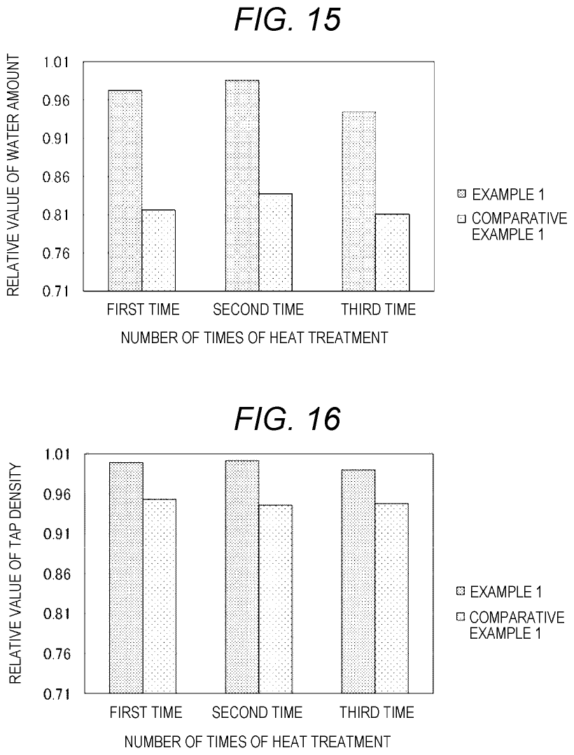

Next, a graph was created based on the measured values. The created graph is shown in FIGS. 15 and 16.

FIG. 15 is a graph showing a relationship between the water amount and the number of times of heat treatment for the powder in Example 1 and the powder in Comparative Example 1.

As shown in FIG. 15, in the powder in Example 1, the change in water amount was sufficiently prevented even when the heat treatment was performed. That is, in the powder in Example 1, the change in water amount was small between after the zeroth heat treatment and after the first to third heat treatments. In contrast, in the powder in Comparative Example 1, the change in water amount was large before and after the heat treatment. That is, the change in water amount was large between after the zeroth heat treatment and after the first to third heat treatments.

FIG. 16 is a graph showing a relationship between the tap density and the number of times of heat treatment for the powder in Example 1 and the powder in Comparative Example 1.

As shown in FIG. 16, in the powder in Example 1, the change in tap density is sufficiently prevented even when the heat treatment was performed. That is, in the powder in Example 1, the change in tap density was small between after the zeroth heat treatment and after the first to third heat treatments. In contrast, in the powder in Comparative Example 1, the change in tap density was large before and after the heat treatment. That is, the change in tap density was large between after the zeroth heat treatment and after the first to third heat treatments.

From the above, it is recognized that the additive manufacturing powder according to the present disclosure can enable good additive manufacturing even when reused.

What is claimed is:

1. An additive manufacturing powder comprising:
a metal powder; and
a film provided on a particle surface of the metal powder and containing a compound derived from a coupling agent having a hydrophobic functional group, wherein
an average particle diameter is 3.0 μm or more and 30.0 μm or less, and
a water amount is measured by a Karl Fischer method before and after the additive manufacturing powder is subjected to a heat treatment at 200° C. for 24 hours in an air atmosphere, and when the water amount before the heat treatment is set to 1, the water amount after the heat treatment is 0.85 or more and 1.15 or less in terms of mass ratio.

2. The additive manufacturing powder according to claim 1, wherein
the hydrophobic functional group is a cyclic structure-containing group, a fluoroalkyl group, or a fluoroaryl group.

3. The additive manufacturing powder according to claim 1, wherein
a tap density is measured before and after the additive manufacturing powder is subjected to the heat treatment, and when the tap density before the heat treatment is set to 1, the tap density after the heat treatment is 0.94 or more and 1.06 or less.

4. The additive manufacturing powder according to claim 1, wherein
the film is a monomolecular film made of the compound.

5. The additive manufacturing powder according to claim 1, wherein
a contact angle of water, which is measured at 25° C. by a θ/2 method in a state where the additive manufacturing powder is spread in a layer form after being subjected to the heat treatment, is 80° or more and 150° or less.

6. The additive manufacturing powder according to claim 1, wherein
the coupling agent is a silane coupling agent, and
when a concentration of a hydroxy group measured by X-ray photoelectron spectroscopy is calculated as a relative value with a concentration of Si being set to 1, the relative value is 0.40 or less.

7. An additively manufactured object comprising:
the additive manufacturing powder according to claim 1; and
a binder that binds particles of the additive manufacturing powder together.
